(19) United States
(12) Patent Application Publication
(10) Pub. No.: US 2015/0353376 A1
(43) Pub. Date: Dec. 10, 2015

(54) PORTABLE WATER PURIFICATION AND STORAGE RESERVOIR APPARATUSES

(71) Applicant: William Lawrence Hanover, River Heights, UT (US)

(72) Inventor: William Lawrence Hanover, River Heights, UT (US)

(21) Appl. No.: 14/730,730

(22) Filed: Jun. 4, 2015

Related U.S. Application Data
(60) Provisional application No. 62/009,511, filed on Jun. 9, 2014.

(51) Int. Cl. C02F 1/00

(52) U.S. Cl. CPC C02F 1/002; C02F 2201/002; C02F 2103/007

(57) ABSTRACT

In some embodiments, a portable water purification and storage reservoir apparatus may comprise a flexible exterior shell comprising a first chamber configured to hold a volume of water and a second chamber configured to hold a volume of water. The first chamber may be positioned within the flexible exterior shell and may comprise a filling aperture. The second chamber may be positioned within the flexible exterior shell with a flexible divider separating the first chamber and the second chamber. A water filter may be configured to communicate fluid from the first chamber into the second chamber through the divider. A fluid outlet may be configured to allow water to be released from the second chamber and out of the apparatus.

### CROSS REFERENCE TO RELATED APPLICATIONS

This application claims priority to and the benefit of the filing date of U.S. Provisional Application No. 62/009,511, filed on Jun. 9, 2014, entitled “PORTABLE WATER PURIFICATION AND STORAGE RESERVOIR APPARATUSES”, which is hereby incorporated by reference in its entirety.

### FIELD OF THE INVENTION

This patent specification relates to the field of water treatment. More specifically, this patent specification relates to potable water purification and storage in the field.

### BACKGROUND

Potable water is essential for life. Without clean drinking water, individuals may be required to drink contaminated water which may result in illness and death. For this reason securing a source of potable water is of paramount concern for individuals in the field. Without such a source, potable water must be carried into the field with significant transportation costs and personal effort. During natural disasters or other situations such as field work, camping, hiking, outdoor living, survival training, and emergency evacuations, naturally occurring sources of water may become contaminated or are at significant risk for becoming contaminated. Without access to water testing equipment, these sources of water must be treated as contaminated and purified before drinking to prevent illness and death.

In order to obtain potable water from naturally occurring and other sources of water, generally two methods seek to address this need. A first option is to chemically treat the water. However, chemically treating water has many disadvantages such as managing and proper measuring of the treatment chemicals, needing to wait a period of time for the chemical treatment to become effective, and tasting and ingesting the treatment chemicals. A second option is to filter the water. Likewise, some common water filtration systems also have many disadvantages such as requiring the manual pumping of water through a filter which provides small quantities of potable water, maintain a steady source of water inflow to the filter during manual pumping, and managing a plurality of water containers that must be used with the pump to store and dispense the potable water.

Other common water filtration systems may not require pumping of water through a filter, but are instead quite large or bulky and difficult to transport, are small and very slow at filtering water, are unable to provide integrated water storage, or are unable to dispense potable water with a practical or useful rate of flow. Additionally, attempting to purify water through boiling has drawbacks such as contaminants being left in the water, requiring long cooling periods, and also requiring large amounts fuel that may be inaccessible e.g. during a flood, etc. Due to these drawbacks, other outdoor use water purification systems fail to meet the unique needs of base-camp living and group water needs which require a useful rate of potable water flow. In situations where many people need access to potable water, a plurality of water filtration systems must be used which often require a significant inventory of replacement parts, are cumbersome to transport, and are difficult to set up.

Therefore, a need exists for novel water purification apparatuses that are configured for compact storage, are light weight, and are easy to transport. There also exists a need for novel water purification apparatuses that do not require chemical treatment, manual pumping, or boiling for the production of potable water. There is a further need for novel water purification apparatuses that do not require a large inventory of replacement parts or managing a plurality of water containers that must be used to store and dispense the potable water. Finally, there exists a need for novel water purification apparatuses that are portable and capable of providing a reservoir of potable water with a usable flow for group water needs.

### BRIEF SUMMARY OF THE INVENTION

A portable water purification and storage reservoir apparatus is provided. In some embodiments, the apparatus may comprise a flexible exterior shell comprising a first chamber configured to hold a volume of water and a second chamber configured to hold a volume of water. The first chamber may be positioned within the flexible exterior shell and may comprise a filling aperture. The second chamber may be positioned within the flexible exterior shell with a flexible divider separating the first chamber and the second chamber. A water filter may be configured to communicate fluid from the first chamber into the second chamber through the divider. A fluid outlet may be configured to allow water to be released from the second chamber and out of the apparatus.

In further embodiments, a portable water purification and storage reservoir apparatus may also comprise a suspension element which may be configured to suspend the apparatus from a plurality of objects. When suspended by the suspension element, the first chamber may be positioned above the second chamber.

In further embodiments, a portable water purification and storage reservoir apparatus may also comprise a second fluid outlet configured to allow water to be released from the second chamber. The second fluid outlet may comprise threading allowing the second fluid outlet to be removably coupled to a hose, camp shower, camp faucet, or any other water utilizing device comprising a complementary threaded connection which may be removably coupled to threading on the fluid outlet.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 illustrates a front elevation view of an example of a portable water purification and storage reservoir apparatus according to various embodiments described herein.

FIG. 2 depicts a perspective view of an example of a portable water purification and storage reservoir apparatus according to various embodiments described herein.

FIG. 3 shows a rear elevation view of an example of a portable water purification and storage reservoir apparatus according to various embodiments described herein.

FIG. 4 illustrates a perspective view of an example of a portable water purification and storage reservoir apparatus according to various embodiments described herein.

FIG. 5 depicts a sectional, through line A-A in FIG. 2, elevation view of an example of a portable water purification and storage reservoir apparatus according to various embodiments described herein.

FIG. 6 shows a front elevation view of an alternative example of a portable water purification and storage reservoir apparatus according to various embodiments described herein.

FIG. 7 illustrates depicts a perspective view of an alternative example of a portable water purification and storage reservoir apparatus with a cover flap in an open position according to various embodiments described herein.

FIG. 8 depicts a perspective view of an alternative example of a portable water purification and storage reservoir apparatus with a cover flap in a closed position according to various embodiments described herein.

FIG. 9 shows a rear elevation view of an alternative example of a portable water purification and storage reservoir apparatus according to various embodiments described herein.

FIG. 10 illustrates a sectional, through line B-B in FIG. 8, elevation view of an alternative example of a portable water purification and storage reservoir apparatus according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

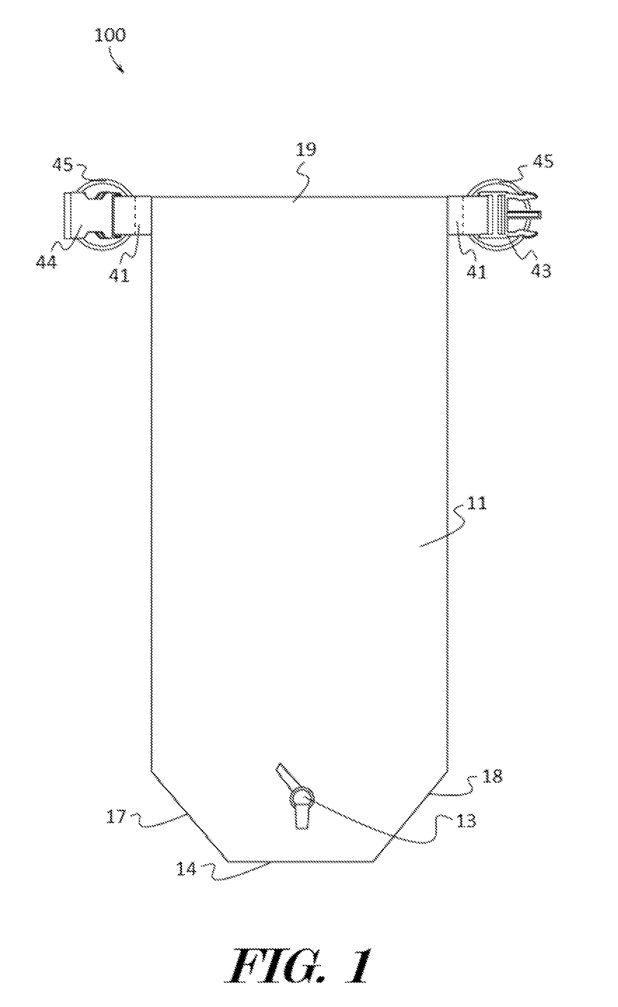

For purposes of description herein, the terms “upper”, “lower”, “left”, “right”, “front”, “back”, “top”, “bottom”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New portable water purification and storage reservoir apparatuses are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIGS. 1-4 illustrate an example of a portable water purification and storage reservoir apparatus (“the apparatus”) 100 according to various embodiments. In this example, the apparatus 100 comprises a flexible exterior shell 11 with a first suspension strap 41, a second suspension strap 41, and a fluid outlet 13 coupled to the exterior shell 11.

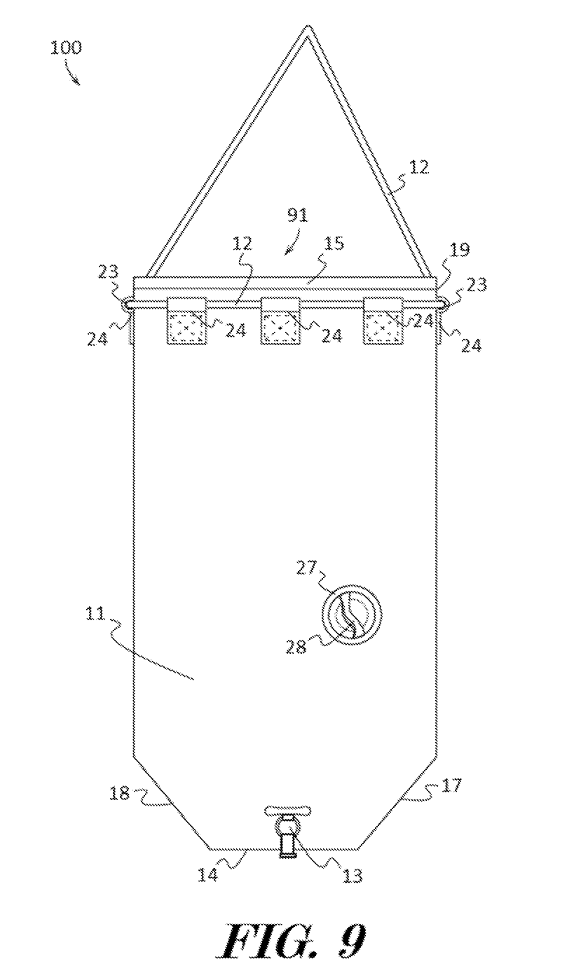

As shown in FIGS. 1-10, the flexible exterior shell 11 may comprise a generally elongated cylindrical shape with the lower portion comprising a frustoconical shape proximate to the base 14 or bottom of the apparatus 100. A frustoconical shape may be provided by one or more tapered sides 17, 18, which may be configured to facilitate the removal of water from the apparatus 100. In other embodiments, the flexible exterior shell 11 may be cuboid shaped, hexagonal prism shaped, triangular prism shaped, or any other geometric or non-geometric shape. In further embodiments, the flexible exterior shell 11 may be generally shaped as a rectangular bag, a conical bag, a triangular bag, or as any other suitable bag shape. It is not intended herein to mention all the possible alternatives, equivalent forms or ramifications of the invention. It is understood that the terms and proposed shapes used herein are merely descriptive, rather than limiting, and that various changes may be made without departing from the spirit or scope of the invention.

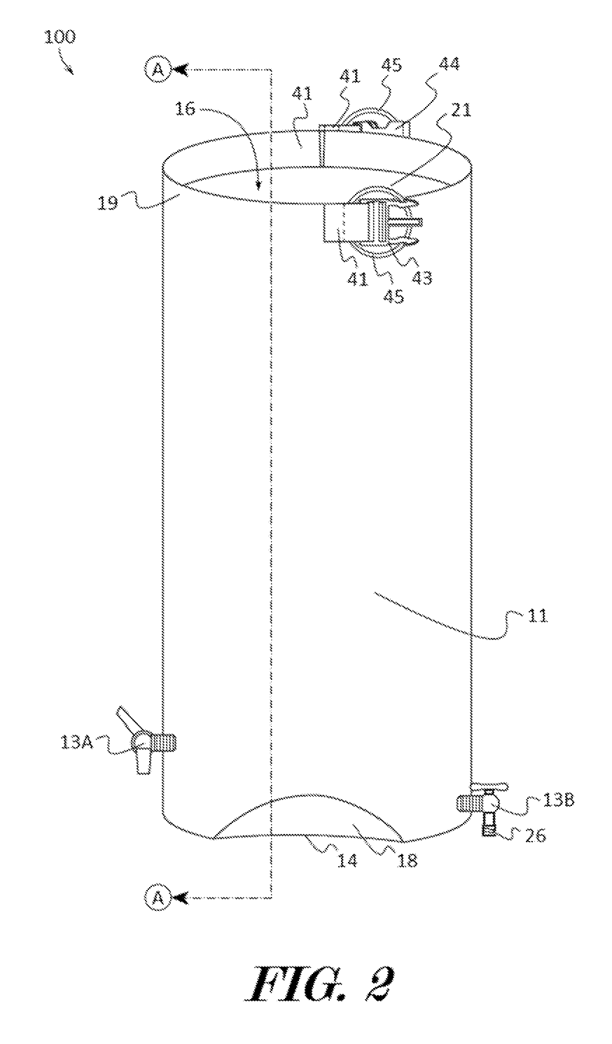

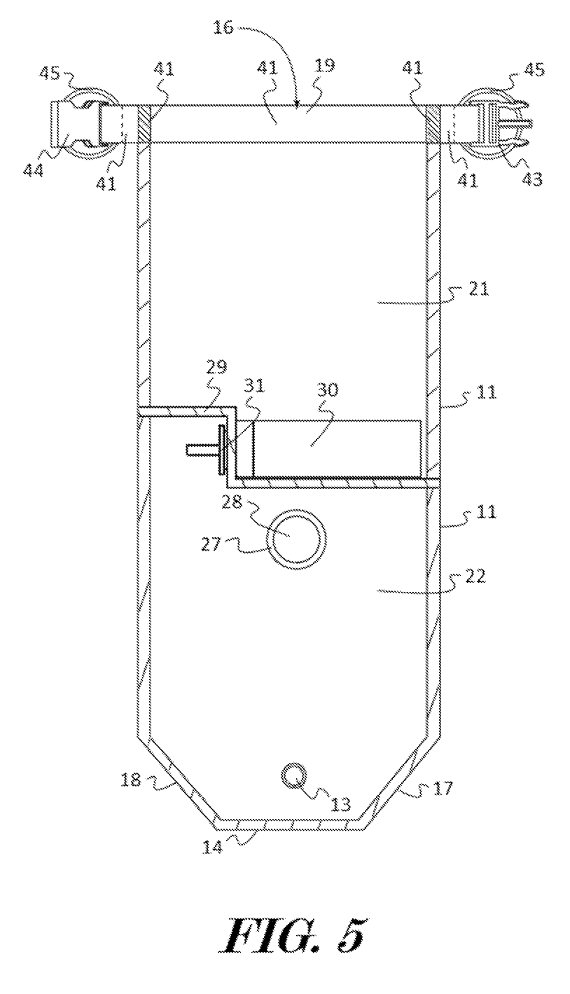

Referring now to FIGS. 1-5, in some embodiments, a filling aperture 16, which is configured to provide access to the first chamber 21 (FIGS. 2 and 5), may be formed by the upper terminus 19 of the flexible exterior shell 11. In other embodiments, the filling aperture 16 may be smaller than the upper terminus 19 of the flexible exterior shell 11 and may be positioned preferably proximate to the upper terminus 19. A first and second suspension strap 41 may be coupled to or proximate to the upper terminus 19 with each suspension strap 41 optionally comprising a suspension strap link 45 and/or a fastener such as a male fastener 43 and a female fastener 44. In further embodiments, each suspension strap 41 may extend around and be coupled to the upper terminus 19 of the flexible exterior shell 11 such as in the first chamber proximate to the upper terminus 19. A suspension strap 41 may be made from a flexible material and may be configured to provide the upper terminus 19 and therefore the filling aperture 16 with a greater amount of rigidity than the rest of the flexible exterior shell 11. In some embodiments, the first and second suspension straps 41 may be sonically welded to the upper terminus 19 with the ends of each strap configured to extend through the exterior shell 11. The ends of the first and second suspension straps 41 may then be sewn together to secure a male fastener 43, a female fastener 44, and/or a suspension strap link 45 on the exterior of the first chamber 21 as shown in FIG. 5.

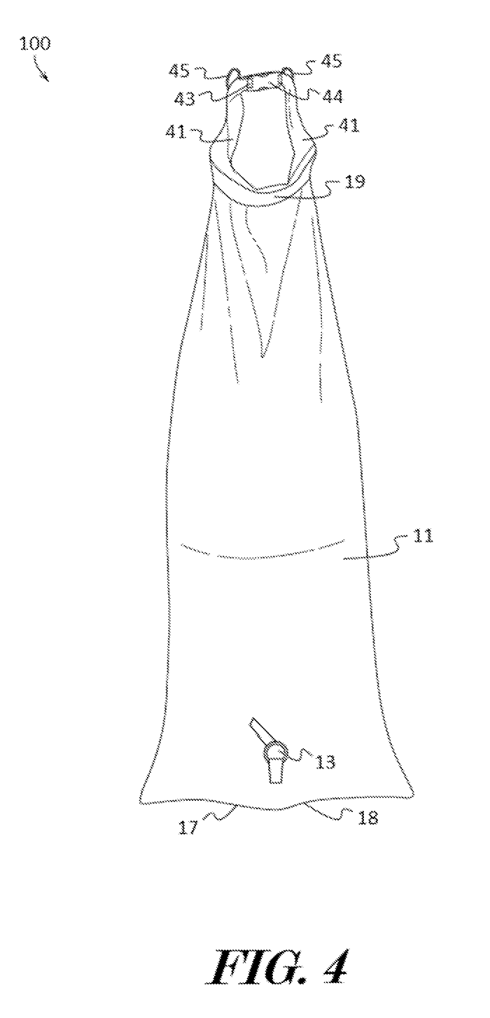

In some embodiments and as shown in FIG. 4, the first and second suspension strap 41 may be removably coupled together by removably coupling a fastener, such as a male fastener 43 of a first suspension strap 41 to the fastener, such as a female fastener 44 of the second suspension strap 41. By removably coupling the first and second suspension strap 41 together around an object, such as a pole, tree branch, rope, and the like, the apparatus 100 may then be suspended by the first and second suspension strap 41 from an object. Additionally, by twisting or rotating the first and second suspension straps 41 relative to the apparatus 100 and/or to each other, the upper terminus 19 of the flexible exterior shell 11 may also be twisted or deformed thereby closing off the filling aperture 16.

In some embodiments, a fastener such a male fastener 43 and female fastener 44 may be claps type fasteners which may be mated to be removably coupled together. In other embodiments, a fastener such a male fastener 43 and female fastener 44 may comprise a side release buckle, buckle, carabineer, hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary or removable connection method as one reasonably skilled in the art could envision to serve the same function of removably coupling a first and second suspension strap 41 together. In further embodiments, the first and second suspension strap 41 may be removably coupled together by removably coupling a suspension strap link 45 of a first suspension strap 41 to the suspension strap link 45 of the second suspension strap 41. In this embodiment, a suspension strap link 45 generally comprises a durable O ring which may receive a rope, strap, chain, carabineer, or any other suitable fastener which may be configured to serve the same function of removably coupling a first and second suspension strap 41 together. In other embodiments, a suspension strap link 45 may comprise a snap hook, D ring, tri-loop, footman loop, or the like which may receive a rope, strap, chain, carabineer, or any other suitable fastener which may be configured to serve the same function of removably coupling a first and second suspension strap 41 together. A suspension strap link 45 and/or a fastener, such as a male fastener 43 and female fastener 44, may be coupled to a suspension strap 41 by being integrally formed or molded together, with heat bonding, chemical bonding, adhesive, stitching, or any other suitable joining method.

In some embodiments, the flexible exterior shell 11 may be made from nylon fabric. In other embodiments, the flexible exterior shell 11 may be made from various types of flexible plastics such as polyvinyl chloride, natural or synthetic rubber, synthetic fabrics such as polyester, acrylic, nylon, rayon, acetate, spandex, lastex, and Kevlar, and natural fabrics such as coir, cotton, hemp, jute, leather, linen, ramie, wool, silk, or any other suitable flexible natural or synthetic material including combinations of materials. In further embodiments, the flexible exterior shell 11 may be made from various types of flexible food-grade materials such as polyurethane, vinyl, polypropelene, high density polyethylene, low density polyethylene, polyvinyl chloride, nylon, rubber, silicone, or any other similar flexible food-grade materials.

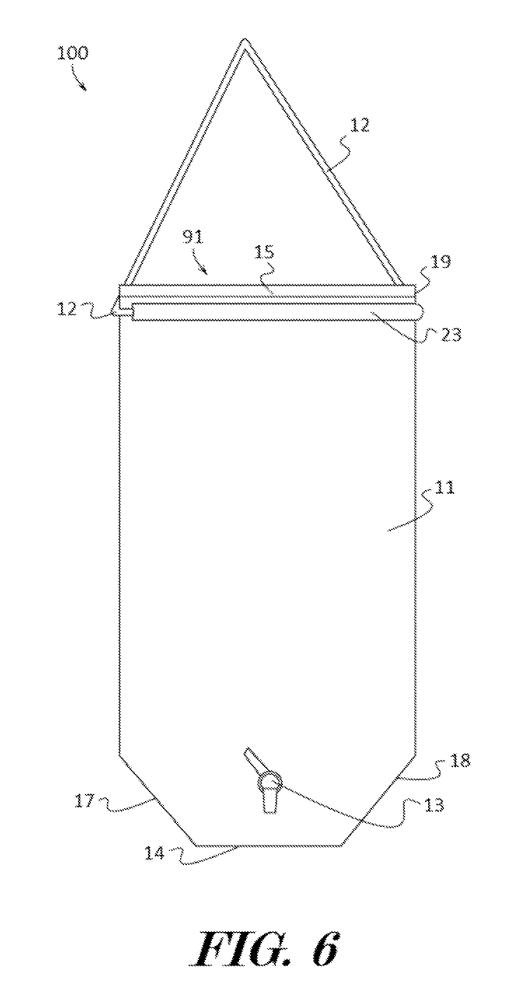

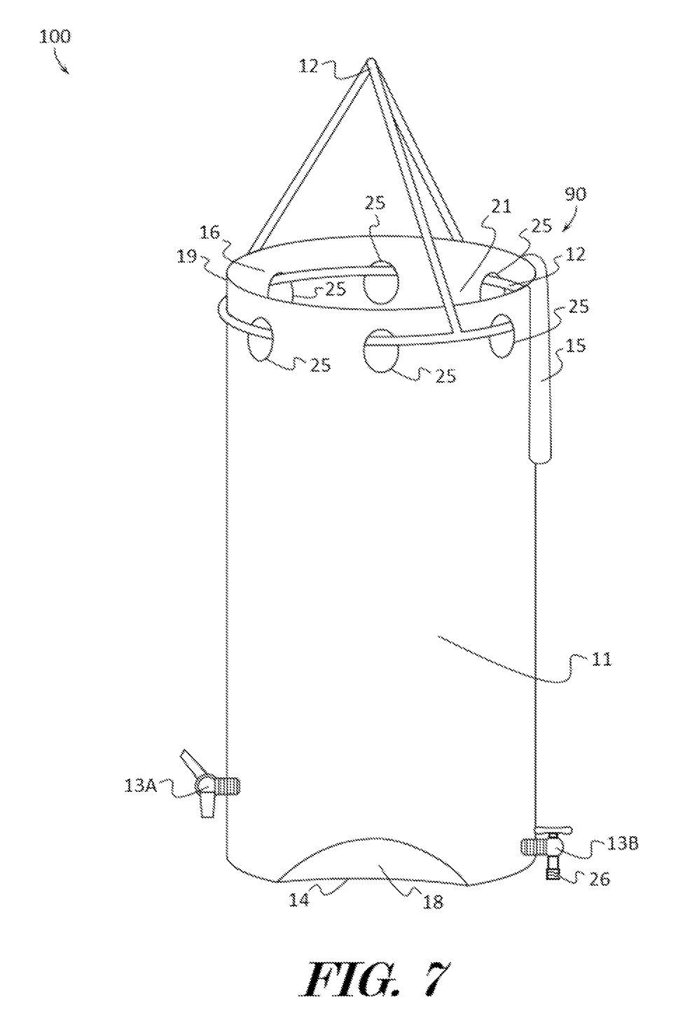

FIGS. 6-10 illustrate an alternative example of a portable water purification and storage reservoir apparatus (“the apparatus”) 100 according to various embodiments. In this example, the apparatus 100 comprises a first chamber 21 positioned within the flexible exterior shell 11 and comprising a filling aperture 16. A second chamber 22 may also be positioned within the flexible exterior shell 11 below the first chamber 21 with a flexible divider 29 separating the first chamber 21 and the second chamber 22. The first 21 and second 22 chamber may each be configured to hold a volume of water. A water filter 30 may be configured to communicate fluid from the first chamber 21 into the second chamber 22 through the flexible divider 29 with a fluid outlet 13 configured to allow water to be released from the second chamber 22 and out of the apparatus 100. The flexible exterior shell 11 may also comprise a cover flap 15 configured to cover the filling aperture 16 (FIG. 7) and optionally other portions of the top of the apparatus 100.

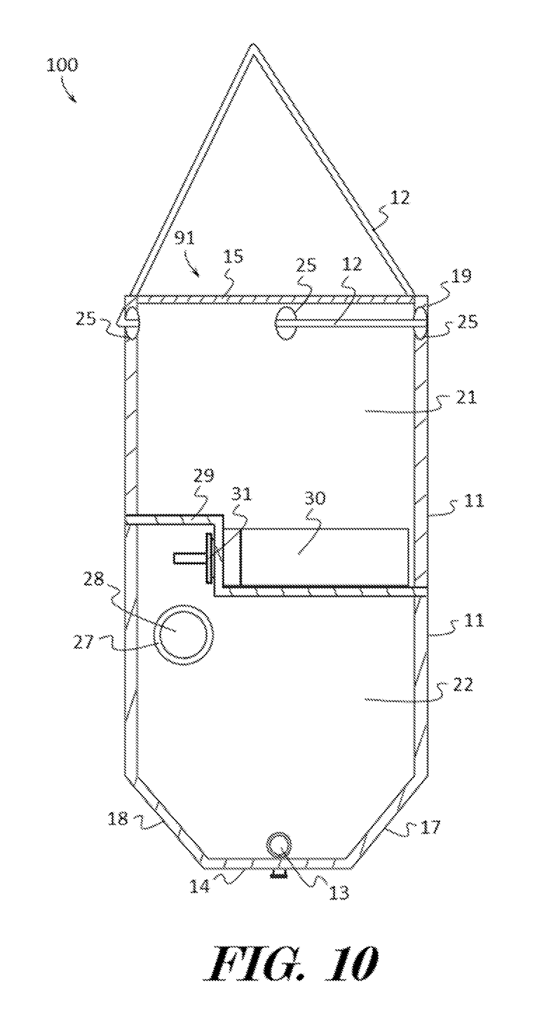

FIG. 7 depicts a perspective view of an example of a portable water purification and storage reservoir apparatus 100 with an optional cover flap 15 in an open position 90 granting access to the filling aperture 16 according to various embodiments described herein. In this embodiment, a filling aperture 16, which is configured to provide access to the first chamber 21 (FIGS. 7 and 10), may be formed by the upper terminus 19 of the flexible exterior shell 11. In other embodiments, the filling aperture 16 may be smaller than the upper terminus 19 of the flexible exterior shell 11 and may be positioned preferably proximate to the upper terminus 19. In some embodiments, a covering such as a cover flap 15 may be temporarily placed over the filling aperture 16. A cover flap 15 may be made from a flexible material such as used to form the flexible exterior shell 11 and may be configured to govern access to the filling aperture 16. In further embodiments, a portion of a cover flap 15 may be coupled or secured to the flexible exterior shell 11, while another portion of the cover flap 15 may be moved between an open position 90 and a closed position 91 (FIGS. 6, 8-10). When in the open position 90, the cover flap 15 may grant access to a first chamber 21 (FIGS. 5 and 10), thereby allowing water to be transferred into the first chamber 21 and/or cleaning of the first chamber 21.

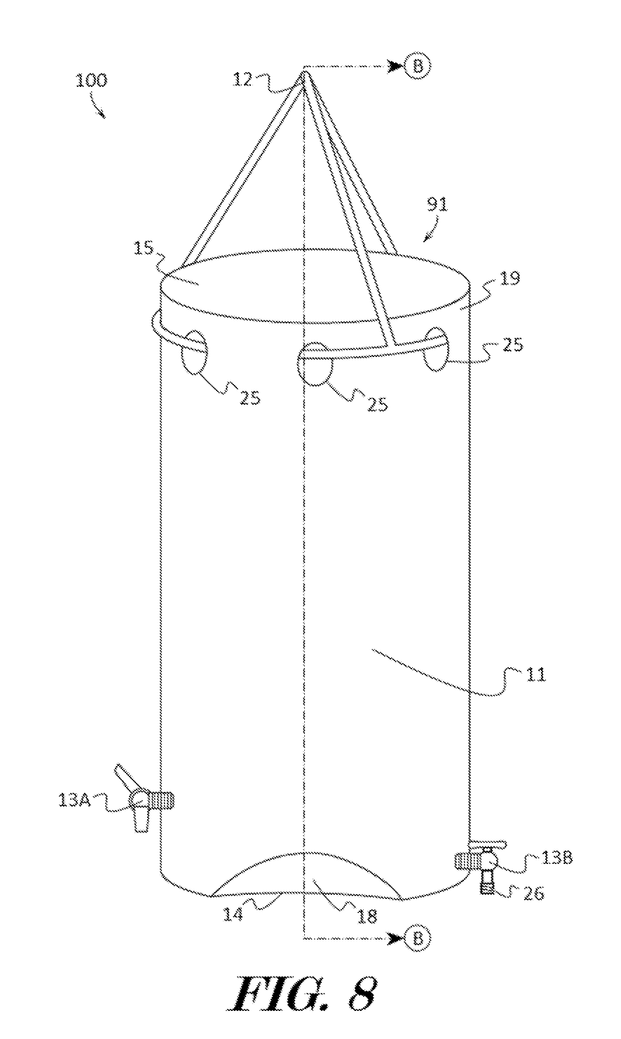

FIG. 8 shows a perspective view of an example of a portable water purification and storage reservoir apparatus 100 with a cover flap 15 in a closed position 91 denying access to the filling aperture 16 according to various embodiments described herein. When moved into a closed position 91, the cover flap 15 may be configured to cover or seal the first chamber 21 (FIGS. 5 and 10) to prevent contaminants from entering the first chamber 21 and/or to optionally prevent water from exiting the first chamber 21 through the filling aperture 16 (FIGS. 2 and 7). In some embodiments, a cover flap 15 may be larger than the filling aperture 16 and/or the upper terminus 19 of the exterior shell 11 allowing the cover flap 15 to simply be placed over the filing aperture 16 and/or the upper terminus 19 when moved into a closed position 91 to deny access to the filling aperture 16. In other embodiments, portions of the cover flap 15 may be removably coupled over or to the filing aperture 16 and/or the upper terminus 19 when the cover flap 15 is in a closed position 91 to deny access to the filling aperture 16. In further embodiments, portions of the cover flap 15 may be removably coupled over or to the filing aperture 16 and/or the upper terminus 19 by being press fit together, by one or more fasteners such as Velcro type fasteners, sealable tongue and groove fasteners, clip type fasteners, clasp type fasteners, ratchet type fasteners, buckle type fasteners and the like, elastic compression, tie downs, or any other temporary joining method. In other alternative embodiments, a covering flap 15 may comprise a rigid material which may be removably coupled over or to the filing aperture 16 and/or the upper terminus 19 when the cover flap 15 is in a closed position 91 to deny access to the filling aperture 16.

As shown in FIGS. 6-10, in some embodiments the apparatus may comprise a suspension element 12 which may be configured to suspend the apparatus 100 from a plurality of objects. A suspension element 12 may be coupled to the flexible exterior shell 11 proximate to the first chamber 21. In further embodiments, a suspension element 12 may be coupled to the flexible exterior shell 11 proximate to the first chamber 21 and proximate to the upper terminus 19 of the flexible exterior shell 11. When suspended by the suspension element 12, the apparatus may be maintained in an upright position in which the first chamber 21 may be positioned above the second chamber 21 as shown in FIGS. 5 and 10.

In some embodiments, a suspension element 12 may be made from or comprise a flexible length of material such as a cord, strap, chain, belt, and the like. In further embodiments, a suspension element 12 may be coupled to the flexible exterior shell 11 by passing portions of the suspension element 12 through portions of the flexible exterior shell 11 such as through a tubular seam 23 as shown in FIG. 6. By passing portions of the suspension element 12 through a tubular seam 23, the suspension element 12 may be configured to act as a draw string to optionally cinch portions of the upper terminus 19 of the flexible exterior shell 11 and/or the filling aperture 16.

In other embodiments, portions of a suspension element 12 made from or comprising a flexible length of material may be passed through one or more suspension tabs 24 each of which may comprise a tubular seam 23 and may be coupled to the flexible exterior shell 11 as shown in FIG. 6 such as with stitching, adhesives, or other suitable joining method. By passing portions of the suspension element 12 through the tubular seams 23 of the suspension tabs 24, the suspension element 12 may also be configured to act as a draw string to optionally cinch portions of the upper terminus 19 of the flexible exterior shell 11 and/or the filling aperture 16.

In still other embodiments, portions of a suspension element 12 made from or comprising a flexible length of material may be passed through one or more securement apertures 25 which may be coupled to or pass through the flexible exterior shell 11 as shown in FIGS. 7, 8, and 10. Optionally, one or more securement apertures 25 may be configured with grommets or other reinforcement means to strengthen the attachment of a suspension element 12 to the flexible exterior shell 11. By passing portions of the suspension element 12 through the securement apertures 25, the suspension element 12 may also be configured to act as a draw string to optionally cinch portions of the upper terminus 19 of the flexible exterior shell 11 and/or the filling aperture 16. In further embodiments, the apparatus 100 may comprise or be coupled to one or more straps, belts, hooks, threaded fasteners, carabineers, or any other connection method which may be configured to secure a suspension element 12 and/or flexible exterior shell 11 to various structures. In even further embodiments, upper portions of the flexible exterior shell 11 may be configured to suspend the apparatus from a plurality of objects.

A portable water purification and storage reservoir apparatus 100 may comprise a fluid outlet 13 (FIGS. 1-10) which may be configured to allow water to be released from the second chamber 22 (FIGS. 5 and 10) and out of the apparatus 100. A fluid outlet 13 may comprise a valve which may be configured to control the release or dispensing of water from the second chamber 22. In some embodiments, a fluid outlet 13 may comprise a spigot type fluid outlet 13A (FIGS. 2, 7, and 8) commonly used to dispense beverage liquids such as a lift-to-actuate nozzle, push-to-actuate nozzle, a turn-to-actuate nozzle, or any other suitable nozzle type device, spigot type device, or any other similar device configured to control the dispensing of liquids.

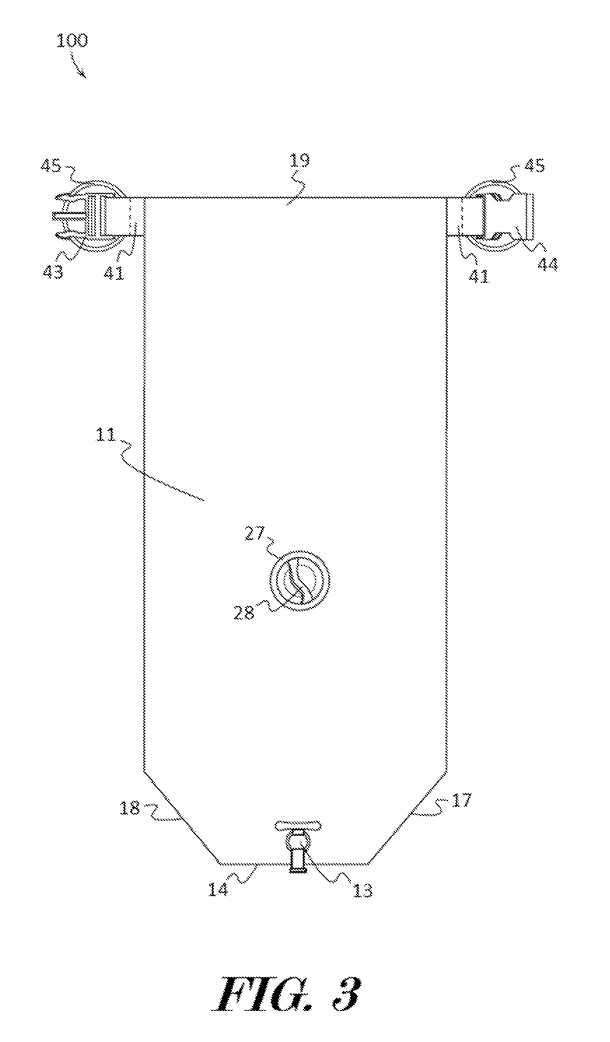

In some embodiments and as shown in FIGS. 2, 7 and 8, an apparatus 100 may comprise a first fluid outlet 13 and a second fluid outlet 13 each of which may be configured to control the release or dispensing of water from the second chamber 22 (FIGS. 5 and 10). In further embodiments, an apparatus 100 may comprise a spigot type fluid outlet 13A and a utility type fluid outlet 13B as shown in FIGS. 2 and 3. In still further embodiments, a fluid outlet 13, such as a utility type fluid outlet 13B, may comprise threading 26 which may be suitable for removably coupling the fluid outlet 13 to a hose, camp shower, camp faucet, or any other water utilizing device comprising a complementary threaded connection which may be removably coupled to threading 26 on the fluid outlet 13.

A fluid outlet 13 may be coupled to the flexible exterior shell 11 with portions of the fluid outlet 13 passing through the flexible exterior shell 11 and into the second chamber 22 (FIGS. 5 and 10), thereby providing fluid communication between the second chamber 22 and the exterior of the apparatus 100. In some embodiments, a fluid outlet 13 may be positioned on the apparatus 100 on or proximate to the optional tapered sides 17, 18, thereby allowing the frustoconical shape to funnel water towards one or more fluid outlets 13. In further embodiments, a fluid outlet 13 may be coupled or joined to the flexible exterior shell 11 with heat bonding, chemical bonding, adhesives, clasp type fasteners, threaded fasteners, other types of fasteners, by being integrally molded or formed together, or any other suitable joining method capable of securing portions of a fluid outlet 13 to the flexible exterior shell 11 in a water tight manner. Preferably, a fluid outlet 13 may be made from food-grade nylon, polyurethane, vinyl, polyethylene, polyvinyl chloride, rubber, silicone, or other similar flexible food-grade material or non-food grade material including combinations of materials.

In some embodiments and in the present example, the apparatus 100 may comprise an access aperture 27 (FIGS. 3, 5, 9, and 10) configured to allow temporary access to the interior of the second chamber 22 (FIGS. 5 and 10). The access aperture 27 may pass through the flexible exterior shell 11 and into the second chamber 22, thereby allowing access to the second chamber 22 from the exterior of the apparatus 100. Access to the second chamber 22 may be used to clean the second chamber 22 and may also allow air to escape from the second chamber 22.

In some embodiments, the apparatus 100 may comprise a cap 28 (FIGS. 3, 5, 9, and 10) which may be configured to govern access to the access aperture 27 (FIGS. 3, 5, 9, and 10). By removably coupling the cap 28 over or to the access aperture 27, the cap 28 may be configured to deny access to second chamber 22 (FIGS. 5 and 10) through the access aperture 27. Conversely, by removing the cap 28 from covering the access aperture 27, the cap 28 may be configured to grant access to second chamber 22 through the access aperture 27. In further embodiments, a cap 28 and an access aperture 27 may comprise threading which is complementary to each other allowing the cap 28 to be threadedly secured over or to the access aperture 27. By loosening the threaded securement between a threaded cap 28 and a threaded access aperture 27, air may be allowed to escape from the second chamber 22. By tightening the threaded securement between a threaded cap 28 and a threaded access aperture 27, air may be prevented from escaping from the second chamber 22. In still further embodiments, a cap 28 may be removably secured over or to an access aperture 27 by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary or removable connection method as one reasonably skilled in the art could envision to serve the same function.

As perhaps best shown by FIGS. 5 and 10, in some embodiments, an apparatus 100 may comprise a flexible exterior shell 11 comprising a first chamber 21 configured to hold a volume of water and a second chamber 22 configured to hold a volume of water. The first chamber 21 may be positioned within the flexible exterior shell 11 and may comprise a filling aperture 16 (FIGS. 2 and 7). The second chamber 22 may be positioned within the flexible exterior shell 11 with a flexible divider 29 separating the first chamber 21 and the second chamber 22. A water filter 30 may be configured to communicate fluid from the first chamber 21 into the second chamber 22 through the divider 29. A fluid outlet 13 may be configured to allow water to be released from the second chamber 22 and out of the apparatus 100.

Referring now to FIGS. 5 and 10, in some embodiments, a first chamber 21 may be defined by a food grade plastic such as polyurethane, vinyl, polypropelene, high density polyethylene, low density polyethylene, polyvinyl chloride, nylon, rubber, silicone, or any other similar flexible food-grade material. The food grade plastic may define the first chamber 21 allowing the first chamber 21 to hold a volume of water. Water may be introduced or added to the first chamber 21 through the filling aperture 16 while a cover flap 15 may be configured to govern access to the filling aperture 16.

In some embodiments, a second chamber 22 may be defined by a food grade plastic such as polyurethane, vinyl, polypropelene, high density polyethylene, low density polyethylene, polyvinyl chloride, nylon, rubber, silicone, or any other similar flexible food-grade material. Optionally, the second chamber 22 may comprise a frustoconical shape which may be provided by one or more tapered side 17, 18. The food grade plastic may define the second chamber 22 allowing the second chamber 22 to hold a volume of water. Water may be introduced or added to the second chamber 22 from the first chamber 21 through a water filter 30, while a fluid outlet 13 may be configured to allow water to be released from the second chamber 22 and out of the apparatus 100.

A flexible divider 29 may be coupled to the flexible exterior shell to separate the first chamber 21 from the second chamber 22. In some embodiments, a flexible divider 29 may be formed by a flexible material such as a food grade plastic such as polyurethane, vinyl, polypropelene, high density polyethylene, low density polyethylene, polyvinyl chloride, nylon, rubber, silicone, or any other similar flexible food-grade material which may be positioned between the first chamber 21 and the second chamber 22. In other embodiments, a flexible divider 29 may be formed by the food grade plastic of the first chamber 21 and the food grade plastic of the second chamber 22.

A water filter 30 may be configured to communicate fluid from the first chamber 21 into the second chamber 22 through the flexible divider 29 so that water may only pass from the first chamber 21 into the second chamber 22 through the water filter 30. In this manner, unfiltered water may be added to the first chamber 21 which may become filtered as it passes into the second chamber 22. In some embodiments, a portion of a water filter 30 may pass through the flexible divider 29 and portions of the exterior of the water filter 30 may be coupled in a water tight manner to the flexible divider 29 with an adhesive, heat bonding, chemical bonding, and the like. As shown in FIGS. 5 and 10, in some embodiments, a water filter 30 may be positioned within the first chamber 21. In alternative embodiments, a water filter 30 may be positioned within the second chamber 22. In other alternative embodiments, an apparatus 100 may comprise one or more water filters 30 which may be positioned within the first chamber 21 and/or the second chamber 22.

In other embodiments, the apparatus 100 may comprise a water filter fastener 31. A portion of a water filter fastener 31 may pass through the flexible divider 29 and portions of the exterior of the water filter fastener 31 may be coupled in a water tight manner to the flexible divider 29 with an adhesive, heat bonding, chemical bonding, and the like. A water filter fastener 31 may removably couple portions of the water filter 30 to the flexible divider 29 in a water tight manner. The water filter fastener 31 may removably couple portions the water filter 30 in a water tight manner to the flexible divider 29 with a threaded connection method, a clasp type connection method, push-to-lock type connection method, a turn-to-lock type connection method, slide-to-lock type connection method or any other suitable temporary connection method as one reasonably skilled in the art could envision to serve the same function. Therefore, once a water filter fastener 31 is secured to portions of the water filter 30 and to the flexible divider 29, water is prevented from passing from the first chamber 21, through the divider 29, and into the second chamber 22 unless the water passes through the water filter 30.

Due to the flexible nature of the flexible divider 29, the divider 29 may be configured to allow a water filter 30 to be positioned generally horizontally when a water filter 30 is secured or coupled to a flexible divider 29. In other embodiments, the flexible divider 29 may be configured to allow a water filter 30 to be positioned generally vertically or in any other orientation when a water filter 30 is secured or coupled to a flexible divider 29.

In preferred embodiments, the flexible divider 29 may be configured as a flexible bowl-shaped “bag” or piece of impermeable material that may provide separation between the first chamber 21 and the second chamber 22 and may be made from various types of flexible plastics such as polyvinyl chloride, natural or synthetic rubber, synthetic fabrics such as polyester, acrylic, nylon, rayon, acetate, spandex, lastex, and Kevlar, and natural fabrics such as coir, cotton, hemp, jute, leather, linen, ramie, wool, silk, or any other suitable flexible natural or synthetic material including combinations of materials. In other embodiments, the flexible divider 29 may be made from various types of flexible food-grade materials such as polyurethane, vinyl, polyethylene, polyvinyl chloride, nylon, rubber, silicone, or any other similar flexible food-grade materials. The flexible divider 29 may comprise an aperture or hole through which a portion of a water filter 30 and/or water filter fastener 31 may pass through. Once the water filter 30 is coupled to the flexible divider 29, it may optionally lay down in a substantially horizontal orientation that may generally create the distortions/contours in the divider as depict in FIGS. 5 and 10.

A water filter fastener 31 may optionally be configured to extend vertically through, and be sealed in a water tight manner to, a flexible divider 29. In the embodiments depicted in FIGS. 5 and 10, a water filter 30 may be horizontally coupled to a water filter fastener 31 allowing the water filter 30 to remain in a generally horizontal position when the first chamber 21 contains water. In other embodiments, a water filter 30 may be joined to a divider 29 with or without a water filter fastener 31 in any other method that one skilled in the art could envision that would enable water to pass from the first chamber 21 and only through a water filter 30 into the second chamber 22.

In some non-limiting examples, a first chamber 21 and/or a second chamber 22 may each be configured to hold five or six gallons of water. In other embodiments, a first chamber 21 and/or a second chamber 22 may each be configured to hold between one and fifty gallons of water. In further embodiments, a first chamber 21 and/or a second chamber 22 may each be configured to hold between fifty and two hundred gallons of water.

While some materials have been provided, in other embodiments, the elements that comprise the apparatus 100 may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the apparatus 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the apparatus 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the apparatus 100 may be coupled by being one of connected to and integrally formed with another element of the apparatus 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A portable water purification and storage reservoir apparatus, the apparatus comprising:
a flexible exterior shell;
a first chamber positioned within the flexible exterior shell comprising a filling aperture, wherein the first chamber is configured to hold a volume of water;
a second chamber positioned within the flexible exterior shell, wherein the second chamber is configured to hold a volume of water;
a flexible divider separating the first chamber and the second chamber;
a water filter configured to communicate fluid from the first chamber into the second chamber through the flexible divider; and
a fluid outlet configured to allow water to be released from the second chamber and out of the apparatus.

2. The apparatus of claim 1, further comprising a first suspension strap and a second suspension strap which may be removably coupled together to suspend the apparatus from a plurality of objects.

3. The apparatus of claim 2, wherein the first chamber is positioned above the second chamber when the apparatus is suspended by the first and second suspension straps.

4. The apparatus of claim 3, wherein the first and second suspension straps are coupled to the apparatus proximate to the first chamber.

5. The apparatus of claim 2, wherein the first and second suspension straps each comprise a fastener, and wherein the fastener of the first suspension strap is configured to be removably coupled to the fastener of the second suspension strap.

6. The apparatus of claim 1, wherein the first and second suspension straps each comprise a suspension strap link.

7. The apparatus of claim 1, further comprising a second fluid outlet configured to allow water to be released from the second chamber.

8. The apparatus of claim 7, wherein the second fluid outlet comprises threading.

9. The apparatus of claim 1, wherein the second chamber comprises a frustoconical shape.

10. The apparatus of claim 1, wherein the water filter may be removably coupled to the flexible divider.

11. The apparatus of claim 1, wherein the water filter may be positioned within the first chamber.

12. The apparatus of claim 1, further comprising a water filter fastener configured to removably couple the water filter to the flexible divider.

13. The apparatus of claim 1, further comprising an access aperture configured to allow temporary access to the interior of the second chamber;

14. The apparatus of claim 14, further comprising a cap configured to govern access to the access aperture.

15. The apparatus of claim 15, wherein the cap is threadedly secured to the access aperture.

16. The apparatus of claim 15, wherein the cap may be configured to allow air to escape the second chamber.

17. The apparatus of claim 1, wherein the second chamber is defined by a food grade plastic.

18. The apparatus of claim 1, wherein the first chamber is defined by a food grade plastic.

19. The apparatus of claim 1, wherein the divider comprises a food grade plastic.

20. The apparatus of claim 1, wherein the fluid outlet comprises a food grade plastic.
